(19) United States
(12) Patent Application Publication
(10) Pub. No.: US 2014/0026454 A1
(43) Pub. Date: Jan. 30, 2014

(54) FRAMES AND FRAME SYSTEMS FOR PORTABLY SUPPORTING INDICIA-BEARING MEDIA

(71) Applicant: Roy Weis, McMinnville, OR (US)

(72) Inventor: Roy Weis, McMinnville, OR (US)

(21) Appl. No.: 13/751,144

(22) Filed: Jan. 28, 2013

Related U.S. Application Data
(63) Continuation-in-part of application No. 13/556,774, filed on Jul. 24, 2012.

(51) Int. Cl. G09F 15/00

(52) U.S. Cl. CPC G09F 15/00
USPC 40/610; 40/606.01

(57) ABSTRACT

A portable sign frame adapted to support an indicia-bearing medium includes a pair of elongate side members aligned in a spaced, planar relationship, and at least three brace members extending between and/or rigidly connecting the side members: a top brace member connects the top portions thereof, a bottom brace member that includes a foot support adapted to receive a user's foot connects the bottom portions thereof, and at least one middle brace member that forms a hand support adapted to receive a user's hand extends between the side members at one or more points between the top and bottom portions. At least one mounting site for an indicia-bearing medium is defined, individually or collectively, by one or more of the top portions of the side members, the top brace member, and the middle brace member.

### CROSS-REFERENCE TO CO-PENDING APPLICATION

This application is a continuation-in-part of, and claims priority to, co-pending U.S. application Ser. No. 13/556,774, filed Jul. 24, 2012, the disclosure of which is herein incorporated by reference in its entirety for all purposes.

### TECHNICAL FIELD

This disclosure relates to hand-held signs, and in particular to hand-held sign frames and sign frame systems to portably support signs.

### BACKGROUND

Businesses have long employed the use of signs to attract, inform, and/or direct customers, such as by advertising a special promotion or event, providing directions to a store location, and so forth. One popular technique is to employ individuals to hold signs outside or otherwise near a business location in an effort to engage passersby, such as stationing a live sign holder on the side of a busy street in order to draw the attention of motorists. It is thought that sign that is displayed by a live sign holder is better at attracting and maintaining attention, as compared to the static nature of fixed signs, because the individual holding a hand-held sign may twirl, wave, or otherwise move the sign around, interact with passersby by waving or gesturing, dress in a costume or otherwise add a performance element to the display of the sign, and so forth.

This technique suffers from some drawbacks, some of which are related to sign visibility. For example, the elevation at which a hand-held sign may be displayed is generally limited to how high a person can raise the sign over his or her head, which may limit the visibility range of the sign. Furthermore, a hand-held sign should be large enough to display information effectively, but if too large, the sign may be too cumbersome (a user may not have a hand free to wave to traffic), block the individual holding the sign from view (reducing the interactive impact of having an individual to hold the sign), and so forth. User fatigue from standing and holding a sign for long periods of time may also be an issue, especially if the individual is expending energy to move him or herself, and/or the sign, around.

### SUMMARY

Various embodiments of a portable sign frame, or portable sign frame system, are disclosed herein.

Briefly, a portable sign frame according to the present disclosure is adapted to support an indicia-bearing medium (e.g., a sign), and includes a pair of elongate side members aligned in a spaced, planar relationship, and at least three brace members extending between and/or rigidly connecting the side members. For example, a top brace member connects the top portions of the side members, a bottom brace member connects the bottom portions of the side members, and one or more middle brace members extend between the side members at one or more points between the top and bottom portions thereof. The bottom brace member includes a foot support adapted to receive a user's foot thereon, and one or more of the middle brace members forms a hand support adapted to receive a user's hand thereon. At least one mounting site for an indicia-bearing medium is defined, individually or collectively, by one or more of the top portions of the side members, the top brace member, and the middle brace member.

In some embodiments, the structural components of the frame are coupled by means of insert portions that are received in corresponding sleeve portions. In such embodiments, the insert portions may telescope with respect to the sleeve portions, and/or be retained in a desired position by means of a retaining device. In such embodiments, the frame may be adapted to be at least partially disassembled by removing one or more inserts from corresponding sleeve portions.

In some embodiments, the middle brace member and/or the frame as a whole is/are adapted to non-deformingly bear a downward force exerted by a user leaning on the middle brace member, such as a user using the frame as a body rest. In some embodiments, one or more extension members may be selectively coupled to the frame, such as to define or extend the one or more mounting sites of the frame.

Some embodiments of a frame system include a frame and a free-standing, ground-engaging stand member adapted to removably receive and support the frame in a substantially upright position.

The concepts, features, methods, and component configurations briefly described above are clarified with reference to the accompanying drawings and detailed description below.

### BRIEF DESCRIPTION OF THE DRAWINGS

FIG. 1 is an elevation view of an example embodiment of a portable sign frame constructed in accordance with the present disclosure, shown supporting a sign thereon, and also shown being held by a user at an inclined angle with respect to the ground surface, with one hand of the user holding a middle brace member of the sign frame, and with one of the user's feet stabilizing a bottom brace member of the sign frame.

FIG. 2 is an elevation view of the portable sign frame and user of FIG. 1, showing the user in a leaning position with arms folded across the middle brace member, and with one of the user's feet stabilizing the bottom brace member flat against the ground surface.

FIG. 3 is an exploded elevation view of the portable sign frame of FIG. 1.

FIG. 4 is an oblique, partial view of the portable sign frame of FIG. 1, illustrating an insert portion received in a corresponding sleeve portion, and an example retaining device being deployed to retain the insert portion in a selected position relative to the sleeve portion.

FIG. 5 is an exploded elevation view of an example embodiment of a portable sign frame somewhat similar to that shown in FIG. 1, and also showing extension members positioned to either side of the upper portion of the frame.

FIG. 6 is an oblique view of an example embodiment of a free-standing, ground-engaging stand member shown receiving the lower portion of the portable sign frame of FIG. 1.

FIG. 7 is an elevation view of another example embodiment of a portable sign frame constructed in accordance with the present disclosure.

FIG. 8 is an exploded elevation view of yet another example embodiment of a portable sign frame constructed in accordance with the present disclosure, including two different configurations of extension members.

FIG. 9 is an exploded elevation view of yet another example embodiment of a portable sign frame constructed in accordance with the present disclosure in a partially modular configuration.

FIG. 10 is an exploded perspective view of an example of a portable sign frame system constructed in accordance with the present disclosure, showing the frame member separated from the free-standing stand member.

FIG. 11 is an exploded perspective view of the stand member shown in FIG. 10.

FIG. 12 is a perspective view of another example of a stand member.

FIG. 13 is an exploded perspective view of the stand member example shown in FIG. 12.

FIG. 14 is a perspective view of a stand member assembly example where two stand members are connected together by brace members.

FIG. 15 is a top elevation view of the stand member assembly shown in FIG. 14.

FIG. 16 is an exploded perspective view of the stand member assembly shown in FIG. 14.

FIG. 17 is an exploded perspective view of another example of a frame system, the frame system including the stand member assembly shown in FIG. 14.

FIG. 18 is a side elevation view of the frame system shown in FIG. 17 on a level surface.

FIG. 19 is a side elevation view of the frame system shown in FIG. 17 on an uneven surface, showing the self-leveling capability of the free-standing, ground-engaging stand member.

FIG. 20 is a close-up, perspective view of a retaining member of the frame system shown in FIG. 17, depicting the retaining member is a retaining position.

FIG. 21 is a close-up, exploded, perspective view of the retaining member shown in FIG. 20.

FIG. 22 is a perspective view of the stand member assembly shown in FIG. 14 including optional ground engaging elements in the form of wheels to facilitate movement of the stand member assembly.

FIG. 23 is a perspective view of the stand member assembly shown in FIG. 14 including optional ground engaging elements in the form of spikes to restrict or prevent movement of the stand member assembly.

### DETAILED DESCRIPTION

Referring to the drawings, a non-exclusive, example embodiment of a portable sign frame 10 is shown in FIGS. 1-6 to assume a generally rectangular shape and a planar configuration, and to define a lower portion, generally designated at 12, supporting an upper display window, generally designated at 14. A sign S is shown mounted to the display window 14, and a user R is shown to be holding the frame upright relative to a ground surface G.

In particular, frame 10 includes a pair of rigid, elongate side members 20 aligned in a spaced, planar relationship, with a series of struts or brace members extending transversely between, and rigidly connecting, the side members. Although different configurations are possible, frame 10 is shown to include a top brace member 22 connecting the top portions of the side members at the top ends thereof, a bottom brace member 24 connecting the bottom portions of the side members at the bottom ends thereof, and a middle brace member 26 connecting the side members at a point between the top and bottom portions. As discussed in greater detail below, in the embodiment shown in FIGS. 1-6, the middle brace member 26 connects the side members 20 at their longitudinal midpoints, but this arrangement is not required to all embodiments.

Thus, in the example embodiment of frame 10, the middle brace member 26 may be thought of as dividing the lower portion 12 from the upper display window 14, which in turn may be thought of as being defined by the top brace member 22 and the top portions of the side members 20. As such, the aforementioned components, such as individually or in combination, provide one or more mounting sites for sign S.

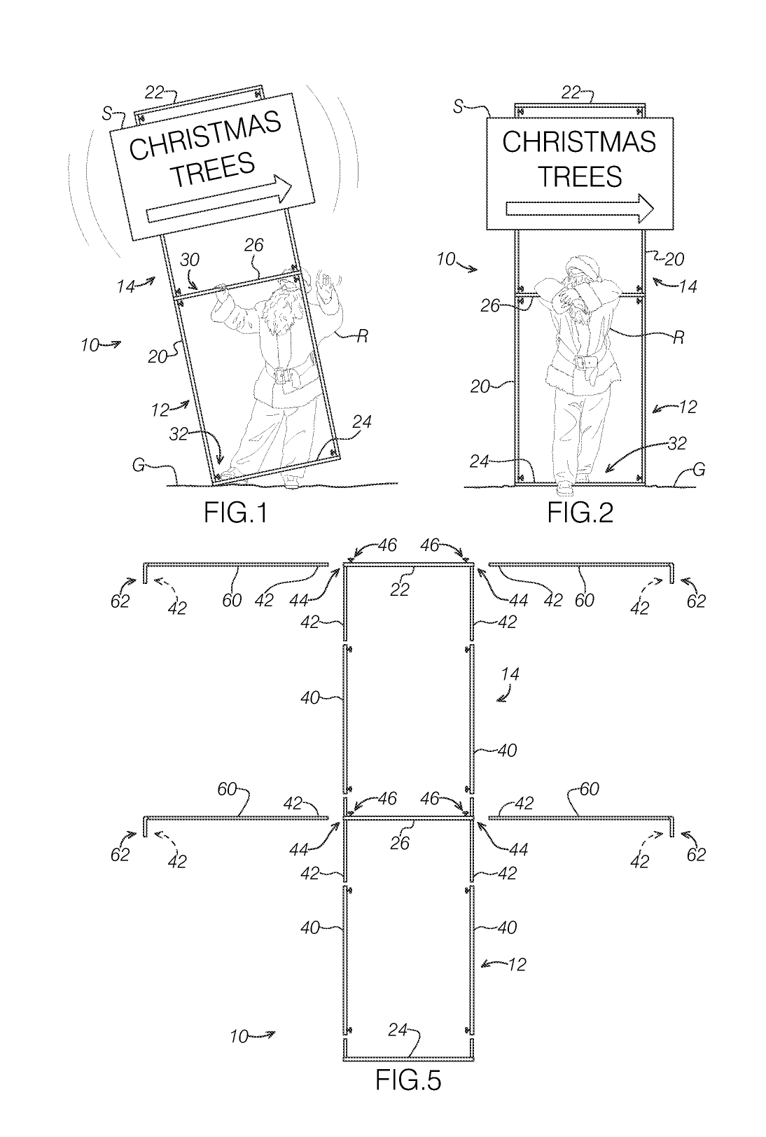

Sign S is shown in FIGS. 1 and 2 as a rigid placard, but may represent any media, or combination of media, that bears, or is otherwise adapted to display or present, indicia. Typically, examples suitable for use with hand-held sign holders include media fabricated from pieces of rigid, lightweight, weather-resistant materials such as laminated board, corrugated plastic, and so forth, or sheets of flexible materials such as plastic-reinforced cloth, laminated paper, and the like. However, other materials or types of media may be used, such as displays including lights or other electronics, and so forth. Accordingly, the mounting site(s) provided by the upper display window, or the components thereof, are not limited in form and may assume any suitable configuration.

Although not specifically shown in the drawings, non-limiting examples of such configurations include nubs, ridges, hooks, or other like projections disposed on the top brace member and/or top portions of the side members, which may be adapted to receive and retain one or more edges and/or surfaces of an indicia-bearing medium; textured, holed, or otherwise configured surfaces to provide friction and/or anchor points for tethering means such as zip-ties or cords, and so forth, that may be employed to retain the indicia-bearing medium against the display window 14; attachment sites for mechanical fasteners such as bolts, clips, and the like; structural components configured to hold or present media, such as brochure sleeves, shelves, and the like; components configured to support lighting, other electronics; magnetic and/or adhesive means; and so forth. Further, the frame may be outfitted with or configured to carry a portable power supply such as a battery case or otherwise, such as to power electronics associated with sign S and/or other media displayed or otherwise supported on frame 10.

Bottom brace member 24 is adapted to engage a ground surface, such as by including a textured or otherwise configured surface to provide a desired degree of friction with the ground surface, and so forth. Optionally, bottom brace member 24 may include ground-engaging pads or feet, such as to prevent contact with the ground surface from effecting wear on the brace member itself, and so forth.

For holding and/or stabilizing by a user, the middle brace member 26, or a portion thereof, forms a hand support 30 adapted to receive a user's hand thereon. Additionally, the bottom brace member 24, or a portion thereof, includes a foot support 32 adapted to receive a user's foot thereon. The hand support 30 and foot support 32 are not particularly restricted in con figuration, and in some embodiments may simply consist of one or more designated surfaces configured for gripping and/or stepping, such as by being suitably shaped, textured, contoured, and so forth. Some embodiments may include additional components, such as one or more padded or cushioned gripping regions disposed on the middle brace member, one or more flattened, textured stepping regions disposed on the bottom brace member, and so forth.

Optionally, other portions of the portable frame may also be configured to receive a user's hand or foot. For example, the lower portion 12 may be provided with additional gripping regions to facilitate a user in carrying the frame sideways or raising the frame above a ground surface, such as to display a sign supported thereon higher in the air; the top brace member may be provided with one or more stepping regions, for example to allow the frame to be used with either end oriented upward, and so forth.

In typical use of the portable sign frame 10, a sign S is mounted to display window 14, and a user R holds the frame upright relative to a ground surface G, such as by holding a hand support 30 of the middle brace member 26 with one or both hands, and/or stepping on a foot support 32 of the bottom brace member 24 with one or both feet. One example of this is shown in FIG. 1, in which a user R is ripping the frame 10 at an inclined angle relative to the ground surface by stabilizing a bottom corner with one foot on foot support 32, and using one hand to hold hand support 30. As such, the user is free to use his other hand to wave at passersby while moving the sign S.

Another example is shown in FIG. 2, in which user R is using the frame 10 as a body rest, by leaning with arms folded across the middle brace member 26, stabilizing the bottom brace member 24 against the ground surface with one or both feet positioned on foot support 32. Of course, sand bags or other weighted objects (not shown) may additionally or alternatively be used to stabilize the bottom brace member 24 against the ground surface. Optionally, some embodiments may incorporate a weighted bottom brace member 24, or may be specifically configured for use with weighted components that may be removably secured to the bottom brace member 24 and/or another component of the frame, such as for additional stability.

The various components of frame 10 are produced from a suitably lightweight and rigid material or materials. For example, in prototype embodiments constructed according to the configuration of frame 10, side and brace members formed from lengths of aluminum tubing having a rectangular cross section of 1″×1.5″ and a wall thickness of approximately 0.050″ were used, with each side member having a length of 60″, and with each of the brace members having a length of 42″, resulting in a frame that is just over 10′ tall and approximately 3′ 8″ wide. The resulting structure (at less than 10 lb., for the prototype embodiment) is sufficiently lightweight to be carried or lifted by a user, or rocked or otherwise moved from side to side by a user when displaying a sign, as shown in FIG. 1, while providing sufficient rigidity and stability to withstand such movement and/or to non-deformingly bear other forces exerted on the frame, such as a downward force from a user using the middle brace member as a body rest, as shown in FIG. 2.

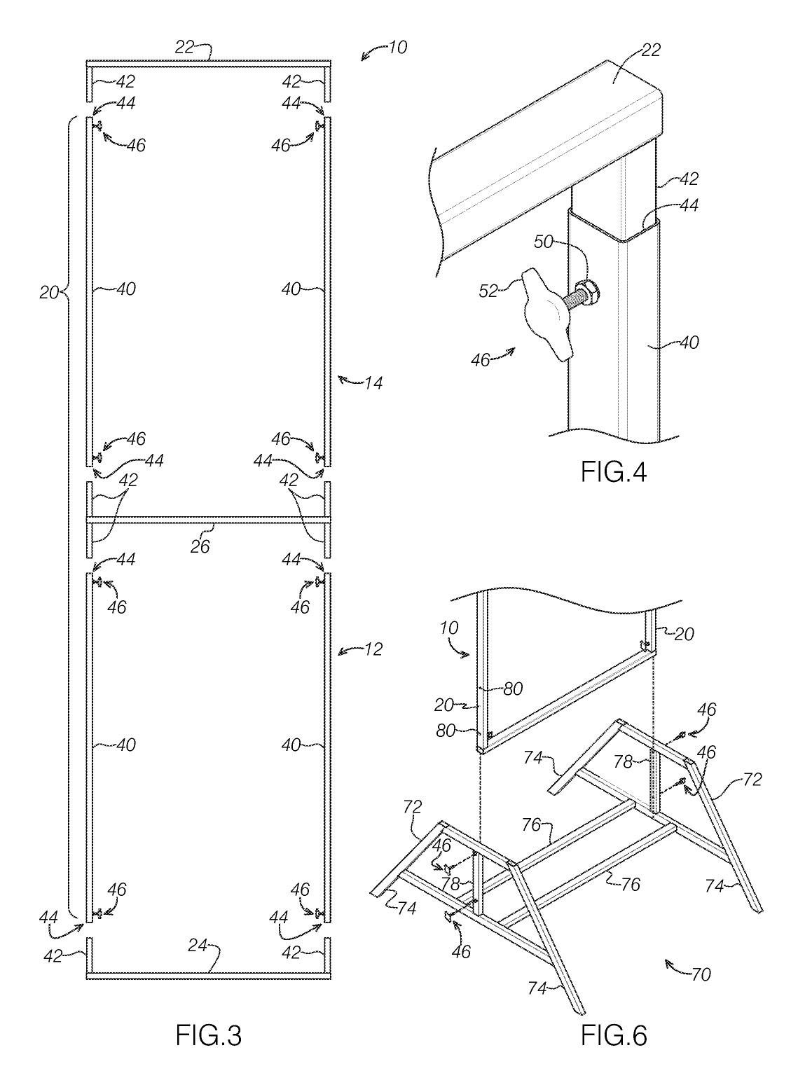

Although not required to all embodiments, frame 10 is of multi-piece construction, assembled from separable components as shown, for example, in FIG. 3. As shown in FIG. 3, the two side members 20 are formed of two pairs of elongate side portions 40. All of side portions 40 are shown to be of identical construction. Further, each of brace members 22, 24, 26 are of similar size. The similar configuration of such components may achieve a lower manufacturing cost and/or require minimal assembly time. Further, providing frame components in a kit to be assembled by an end user may reduce shipping and storage costs.

A number of different assembly techniques and/or features may be implemented in embodiments of portable sign frames according to the present disclosure. One non-limiting, illustrative example is shown in frame 10 in FIG. 3, in which the components are assembled by means of a number of insert portions 42 that each may be removably received in a corresponding sleeve portion 44, and retained therein by a number of retaining devices 46. More particularly, each of the top and bottom brace members 22, 24 include a pair of transversely projecting insert portions 42, and the middle brace member 26 includes two opposed pairs of transversely projecting insert portions 42, with each insert portion disposed at the ends of the respective brace member. The respective insert portions 42 are arranged to be received into corresponding sleeve portions 44 disposed at either end of each side portion 40. In a prototype embodiment following the con figuration illustrated in FIG. 3, sleeve portions 44 consist of the end regions of the lengths of tubing from which side portions 40 are formed, and insert portions 42 consist of 6″ lengths of aluminum tubing having a cross-section sized to be slidably received in the sleeve portions.

A non-limiting example configuration of one of retaining devices 46 is shown in FIG. 4 to assume the form of a standard nut 50 welded to an outside surface of side portion 40 and centered on a hole (not shown) formed therein, into which may be threadably received a standard wing or fin bolt 52. As such, insert portion 42 may telescope within a range of positions relative to the sleeve portion 44, and held in a desired position by tightening fin bolt 52. The range of positions may be continuous, such as if the fin bolt biases directly against the respective surface of the insert portion 42 received in the sleeve portion 44, or discrete, such as if a series of holes or detents are provided in insert portion 42 that may be moved into registration with the hole in the sleeve portion that receives the fin bolt, and so forth. Optionally, other retaining devices, or combinations of retaining devices, may be employed in embodiments of the portable sign frames of the present disclosure, including a snap-fit mechanism, a spring-biased nub and detent system, and so forth.

In embodiments constructed according to FIG. 3, the size of the range of telescoping positions may be adjusted by providing insert portions having longer or shorter lengths than as shown, which may in turn provide a portable sign frame of an adjustable size (e.g., having one or more adjustable dimensions). Optionally, the portable sign frames of the present disclosure may include, and/or be adapted to support, additional frame components, such as to increase the total area that may be used to support a sign, to support multiple signs, and so forth.

One example of an embodiment that includes a greater range of telescoping positions, such as in order to achieve an adjustable total height, and that is also adapted to support additional frame components, is shown in FIG. 3. FIG. 5 includes components that are arranged, configured, and numbered similarly to those discussed above and shown in FIGS. 1-4 to indicate that the additional features shown in FIG. 5 may (but are not required to) be incorporated into the previously-described and illustrated embodiment. Specifically, FIG. 5 includes a composite frame 10 assembled from a set of side portions 40 and brace members 22, 24, and 26. However, brace members 22 and 26 are each shown to include a pair of downwardly extending inserts 42 of greater length, and side portions 40 of shorter length, than as shown in FIG. 3.

Specifically, in one configuration, the downwardly extending inserts 42 are 20″ long, and the side portions are 48″ long (as opposed to 6″ long inserts and 60″ long side portions in the aforementioned prototype embodiments constructed according to FIG. 3). In such a configuration, the overall height of the frame may be adjusted from about 9′ to 12′, but a number of different dimensional ranges may be provided in this manner.

Frame 10 in FIG. 5 is also shown to include a number of extension members 60 that are each adapted to couple with and rigidly extend from either side of frame 10. In particular, extension members 60 are each provided with an insert portion 42 that is adapted to be received in corresponding sleeve portions 44 disposed on the opposed ends of the top and middle brace members 22, 26. Additionally, top and middle brace members 22, 26 are shown to be provided with retaining devices 46, in the form of a fin bolt and nut assembly as discussed above, that may be employed to retain the extension members in position relative to the brace members. Each extension member 60 may define one or more additional mounting sites for a sign, as discussed above, or may extend or otherwise supplement the existing mounting site(s) defined by the other components of the frame 10.

In a prototype embodiment following the illustrated configuration, extension members 60 are constructed of straight lengths of aluminum tubing having a cross-section dimensioned to be slidably received in the aluminum tubing forming the brace members 22, 26, and thus may be telescoped with respect to the brace members as discussed above.

As shown, extension members 60 effectively expand the planar surface provided by display window 14, and as such may serve to provide a larger support framework upon which may be stably supported a larger sign. Optionally, one or more smaller signs may be displayed to either or both sides of a sign mounted to the display window 14, such as by being hung from the extension member(s). Accordingly, extension members 60 are each shown to be provided with an angled end portion 62, which may prevent a hung sign from sliding off the end of the extension member, such as if the frame 10 is tipped or moved around by a user holding the frame.

Optionally, the angled end portions 62 may function as insert portions 42, allowing a user additional configurational options in assembling frame 10. For example, instead of increasing the effective width of the frame by coupling the extension members 60 to the frame 10 as shown, the effective height of the frame 10 may be increased by coupling the angled end portions 62 of the topmost extension members to the top brace member 22, with the longer portions of the extension members 60 extending vertically therefrom.

Optionally, in some embodiments, extension members 60 may be coupled to frame 10 to extend in a different plane than that defined by the side and brace members of the frame itself. For example, with extension members 60 shown in FIG. 5, an angled end portion 62 may be used as an insert portion 42, as explained above, but with the longer portion of the extension member extending orthogonally from the plane defined by the frame. The angle defined by the angled end portion 62 is shown to be 90 degrees, but other angles may be used. Such embodiments may facilitate displaying multiple signs oriented in different directions.

An example embodiment of a stand member 70 is shown in FIG. 6 to be configured for free-standing, ground-engaging, upright support of a portable sign frame, such as frame 10, for example to display the frame without requiring the support thereof by a user. In particular, although many configurations are possible, stand member 70 is shown in FIG. 6 to include a pair of opposing, truncated, upright sections 72 supported on a ground surface by a plurality of legs 74 and connected by a pair of parallel cross members 76. Each upright section 72 is shown to include a vertical brace 78 aligned to receive and selectively couple with a portion of frame 10 to support the frame in a substantially upright position.

In particular, in the illustrated embodiment, the vertical braces 78 are spaced by a distance slightly greater than the width of the frame 10 as defined by the side members 20 thereof, such as to receive the lower portion of the frame with the outward-facing surfaces of the side members 20 against the inward-facing surfaces of vertical braces 78. Further, each vertical brace 78 is provided with a retaining device 46, which is shown in the form of a fin bolt and nut assembly as discussed above, such as to retain the side members in place relative to the stand. Side members 20 may be provided with one or more receiving holes or detents 80 configured to receive the end of the fin bolt when tightened, such as to achieve a more secure fit. As noted above, additional stability may be provided during use such as by placing sand bags or other weighted objects across the cross members 76.

Optionally, some embodiments of a stand member may incorporate weighted structural components (such as legs 74, etc.), and/or may be specifically configured for use with weighted components that may be removably secured to the one or more components of the stand member, such as for additional stability.

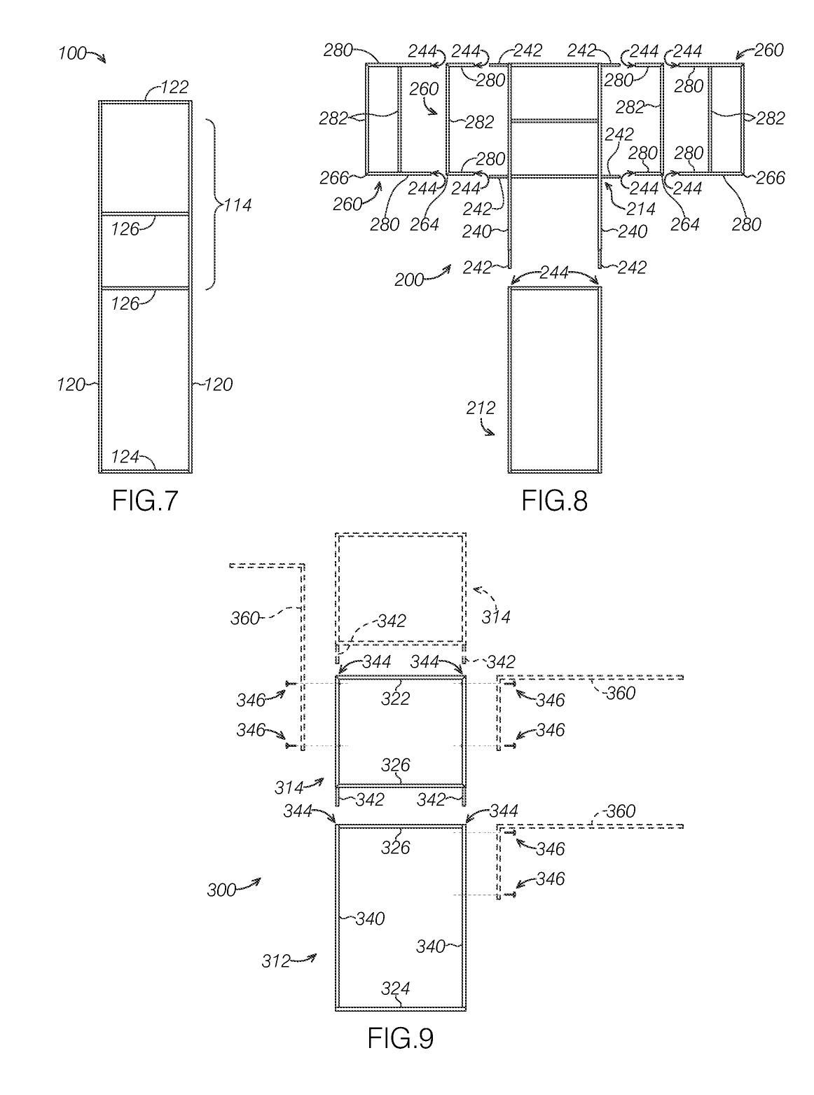

Employing the concepts and components discussed above, a variety of frame configurations are possible without departing from the scope of the disclosure. Some additional non-exclusive example configurations are discussed in the paragraphs below with respect to FIGS. 7-9. Where appropriate, the reference numerals from the example embodiment of FIGS. 1-6 are reiterated, generally in increments of 100, to designate corresponding parts of the portable sign frames, as well as the assemblies and/or components thereof. For brevity, each previously discussed component or variants thereof may not be illustrated or otherwise discussed again with respect to later-discussed embodiments, however, it is within the scope of the present disclosure that the previously discussed aspects may be utilized with any of the portable sign frames described herein.

FIG. 7, for example, shows a further example of a portable sign frame as frame 100, which is shown to have a pair of parallel side members 120 joined by four brace members: a top brace member 122, a bottom brace member 124, and two middle brace members 126. The provision of two middle brace members may provide a display window 114 of a larger size, such as compared with that of frame 10, and/or a display window provided with an additional reinforcing member. Alternately, if inverted 180 degrees from the orientation shown in FIG. 7, the additional middle brace member 126 may provide additional points at which a user may support the frame, such as with a hand or another part of the body. Additionally, frame 100 is shown to be of unitary construction (or, in other words, not adapted for selective disassembly). As such, frame 100 may require less time and materials to manufacture, resulting in reduced fabrication cost, as compared with frame 10.

FIG. 8 shows an example embodiment of a portable sign frame that may provide a structural framework adapted to support a very wide sign, or several signs arranged side to side, as frame 200. Frame 200 is shown to include a display window 214 that may be selectively assembled with a lower portion 212, such as by means of insert portions 242 extending downwardly from side portions 240 of the display window 214, which may be received and retained in corresponding sleeve portions 244 disposed in the top ends of side portions 240 of the lower portion 212. Lower portion 212 is shown to include a first middle brace member 226, and display window 214 is shown to be provided with two additional middle brace members 226, as well as a top brace member 222. Additional insert portions 242 are shown to project outwardly from the side portions 240 of the display window 214, such as to removably support extension members 260. Although not specifically shown in this view, the various insert portions 242 may be retained in the corresponding sleeve portions 244 by means of suitable retaining means, such as a fin bolt and nut assembly as discussed above, or otherwise.

Extension members 260 are shown in two configurations, a “C” configuration (indicated at 264) and a “reinforced C” configuration (indicated at 266). Each extension member configuration includes two horizontal arms 280 connected by a vertical strut 282 and each terminating in a sleeve portion 244 adapted to receive an insert portion 242. The “reinforced C” configuration 266 includes longer arms 280 and an additional vertical strut 282 extending therebetween. In assembling frame 200, the choice of whether to use extension members 264 or 266 may be determined by the width and/or number of signs to be displayed. For example, the side members 220 of frame 200 may provide the display window 214 with a width of 30″, whereas adding both extension members 264 may increase this width to 48″, and whereas adding both extension members 266 instead may increase this width to 60″. In commercial embodiments, the various components may be provided as a kit, for example to allow a user to determine the overall configuration of the portable sign frame 200 when assembled.

FIG. 9 shows an example of a portable sign frame, the components of which have an even more modular character, as frame (or frame system) 300. More specifically, portable sign frame 300 is shown to include a rectangular lower portion 312 consisting of two side portions 340 connected at the top and bottom ends thereof by a middle brace member 326 and a bottom brace member 324, respectively, to which may be attached a rectangular display window module 314 of somewhat similar construction (namely, two side portions 340 connected at the top and bottom ends thereof by a top brace member 322 and a middle brace member 324, respectively), but having insert portions 342 projecting from the bottom corners thereof. Lower portion 312 includes corresponding sleeve portions 344 disposed at the top corners thereof, for receiving and retaining the insert portions therein, such as via suitable retaining means (not shown, for clarity). The display window module 314 at its top corners include sleeve portions 344, which may allow a second display window module 314 (shown in dashed lines) to be coupled to the frame as shown, and so forth.

One or more optional L-shaped extension members 360, also shown in dashed lines, may be coupled to the frame in any of a variety of positions, such as those shown in FIG. 9, in any suitable manner, such as by retaining devices 346 in the form of fin bolt and nut assemblies, or otherwise. The modular nature of the components of frame system 300 may allow a user many options in assembling the structural configuration of a frame, while offering a lightweight, portable sign display for one or more signs.

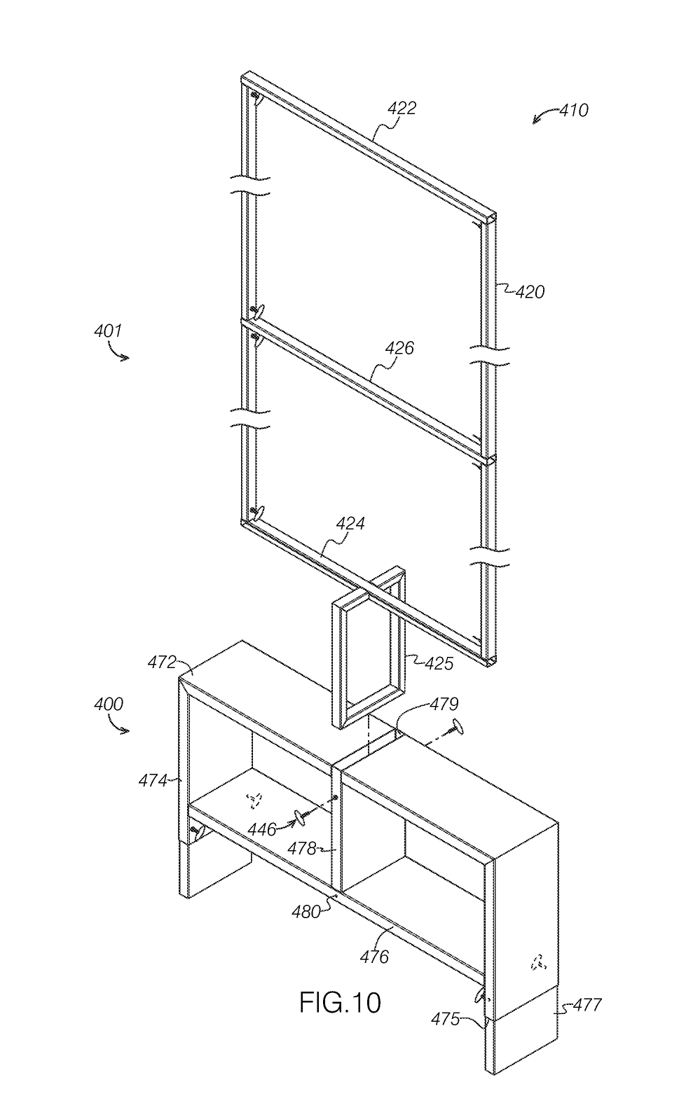

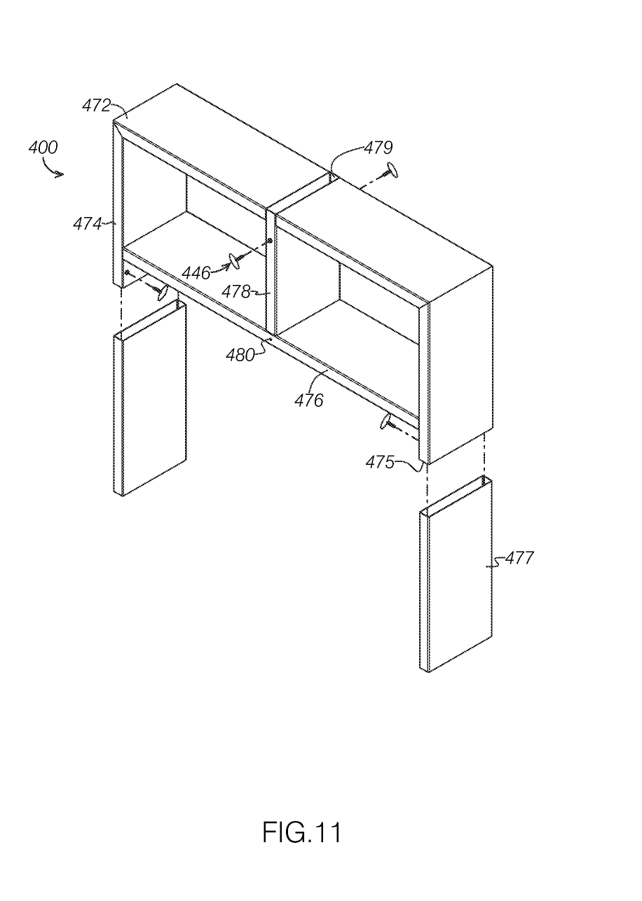

Turning now to FIG. 10, yet another example of a portable sign frame system, frame system 401, is depicted. Frame system 401 includes a frame member 410 and a free standing stand member 400. Frame system 401 serves to support media, such as signs, banners, pictures, and the like, in a free-standing fashion, i.e., without requiring a user to hold up or support the frame system. The reader will readily appreciate that by being free-standing, frame system 401 provides a convenient, less energy intensive and economical solution to support and display media.

Frame member 410 is configured to support media and includes elongate side members 420, a top brace member 422, a middle brace member 426, and a bottom brace member 424. As shown in FIG. 10, bottom brace member 424 defines an insert portion 425.

As in previously described embodiments, frame member 410 is adapted to selectively telescope to facilitate or allow use of various lengths and widths of advertising media. Additionally, insert portion 425 is adapted to be removably received in a sleeve portion 479 of stand member 400.

Stand member 400 is configured to support frame member 410 in a free-standing or self-supporting fashion. As shown in FIG. 10, stand member 400 includes outer vertical members 474, a top horizontal member 472, and a bottom horizontal member 476. Central vertical member 478 defines sleeve portion 479 adapted to removably receive insert portion 425 of frame member 410. Moreover, central vertical member 478 includes retaining members 446 fixedly attached to the exterior of vertical member 478.

Retaining members 446 are selectively adjustable to allow insert portion 425 to telescope within sleeve portion 479. As depicted in FIG. 10, vertical member 478 and sleeve member 479 are sized to accommodate insert portion 425 to allow all or the majority of insert portion 425 to telescope within sleeve portion 479. It is contemplated that vertical member 478 and sleeve member 479 may be configured in any manner to selectively receive insert portion 425, such that frame member 410 is supported in a substantially upright position.

Stand member 400 is configured to be self-leveling, i.e., to adjust to a position where horizontal members 472 and 476 are substantially level, when the terrain on which stand member 400 rests is uneven. Shown perhaps most clearly in FIG. 11, vertical members 474 define sleeve portions 475 proximate the ground and configured to receive ground engaging members 477.

Ground engaging members 477 are configured to selectively telescope within sleeve portions 475 to extend from sleeve portions 475 different distances as warranted by the terrain. In particular, each ground engaging member 477 can be adjusted to extend from its respective sleeve portion 475 a distance sufficient to reach the ground beneath it when horizontal members 472 and 476 are maintained in a substantially horizontal position. The distance extended by one ground engaging member may be independent of, i.e., different than, the distance extended by the other ground engaging member when the terrain is uneven. Of course, the ground engaging members may be extended the same distance when the ground is level.

As depicted in FIGS. 10 and 11, vertical member 478 and sleeve member 479 are rigidly connected to top horizontal member 472 and bottom horizontal member 476 it is contemplated that vertical member 478 and sleeve member 479 may be non-rigidly mounted to top horizontal member 472 and bottom horizontal member 476 to facilitate or allow the frame member to remain substantially upright when stand member 400 is placed on uneven terrain.

Additionally, horizontal member 476 defines anchor point 480. Anchor point 480 defines a window through horizontal member 476, and facilitates or allows stand member 400 to withstand more severe weather conditions. For example, anchor point 480 may be used as a tie-down point to allow stand member 400 to resist high wind speeds. Additionally, anchor point 480 may be configured to accommodate different anchors including, but not limited to, rope, straps, sand bags, and weighted bars.

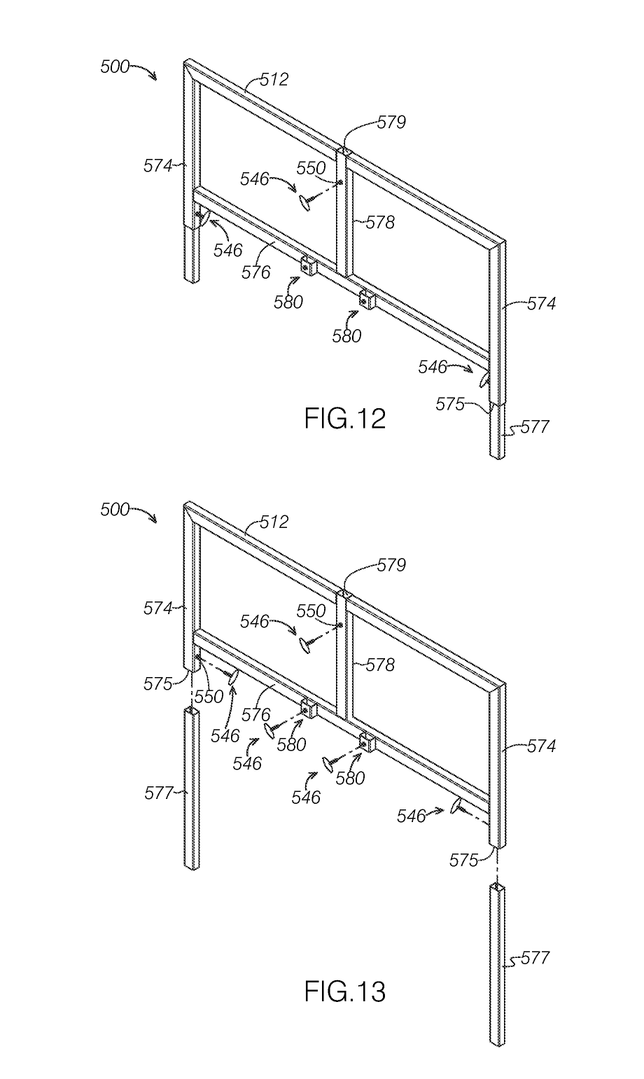

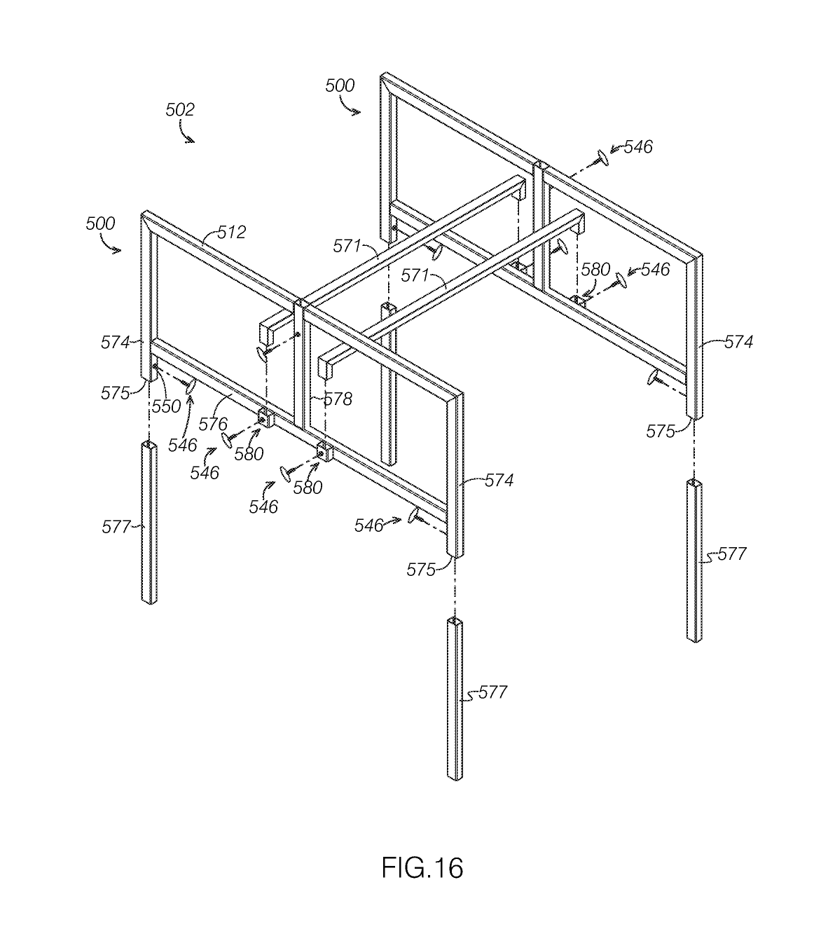

Turning now to FIGS. 12-17, another frame system embodiment, frame system 501, will be described. Frame system 501 includes many similar or identical features as frame system 401, which will not be redundantly explained. Instead, the reader should reference the discussion above for similarly numbered features.

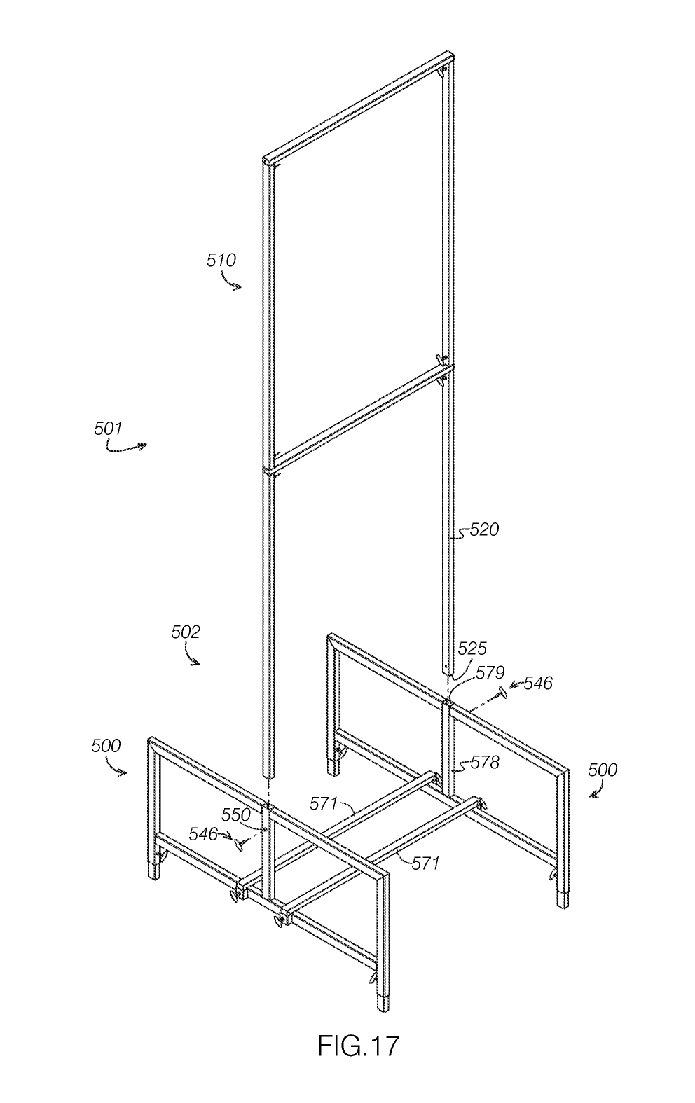

By comparing FIG. 17 with FIG. 10, the reader can see that frame system 501 differs from frame system 401, in part, because it includes a stand member assembly 502 as compared to stand member 400. Stand member assembly 502 includes two side members 500 spaced apart by connecting members 571. As shown in FIG. 17, stand member assembly 502 is configured to be free-standing or self-supporting and to support a frame member 510.

Side members 500 of stand member assembly 502 are similar in many respects to stand member 400. Indeed, side members 500 cooperate together and with connecting members 571 to support frame member 510. By comparing FIGS. 10 and 11 with FIGS. 12-19, the reader can see that side members 500 are narrower than stand member 400.

As shown in FIGS. 12-19, side member 500 includes vertical members 574 connected by a top horizontal member 572 and a bottom horizontal member 576. Additionally, a vertical member 578 of side member 500 bisects top horizontal member 572 and defines a sleeve portion 579. Sleeve portion 579 is configured to receive an insert portion of the frame member. Further, vertical members 574 define sleeve portions 575 proximate the ground and configured to receive ground-engaging insert portions 577.

Retaining members 546 are configured to selectively engage each sleeve portion of stand member 500 to selectively retain each respective insert portion. As shown in FIGS. 12 and 13, members 574 and 578 define adjustment openings 550 through which retaining member 546 insert to engage insert portions positioned within members 574 and 578. In the example shown in the figures, adjustment opening 550 defines a threaded bore, but may define a smooth bore in other examples.

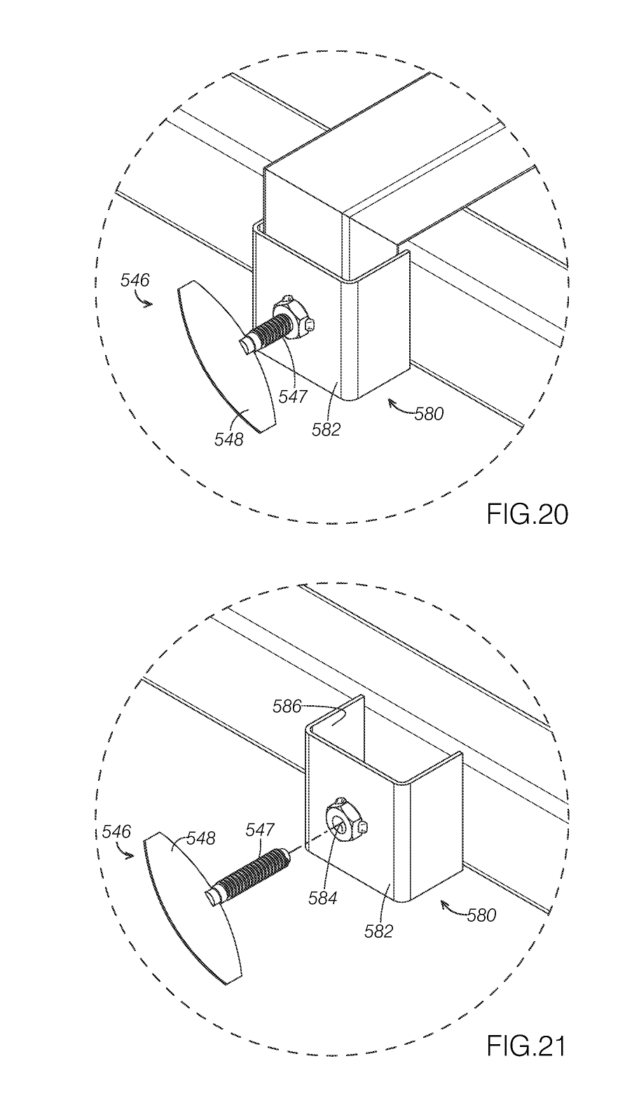

in the examples shown in FIGS. 12-23, and perhaps shown most clearly in FIGS. 20 and 21, retaining member 546 includes a threaded shaft 547 and a head 548 for rotating retaining member 546. However, in other examples, the retaining member may not be threaded and may not include a head configured as shown in FIGS. 12-23. The diameter of the shaft of retaining member 546 is complimentarily configured with the diameter of the bore defined by adjustment opening 550.

When inserted into adjustment opening 550, retaining member 546 may secure components of frame system 501, such as ground-engaging insert portions 577, in a user-selected position, such as a given distance extended from sleeve portions 575. Retaining member 546 is configured to extend through adjustment opening 550 and press against a component adjacent to adjustment opening, such as ground engaging insert member 577. In addition to the currently preferred embodiment depicted in the figures, it is contemplated that any currently known or later developed retaining device may be used including, but not limited to, bore-and-pin, screw-and-threaded-bore, and clamp-style retaining devices.

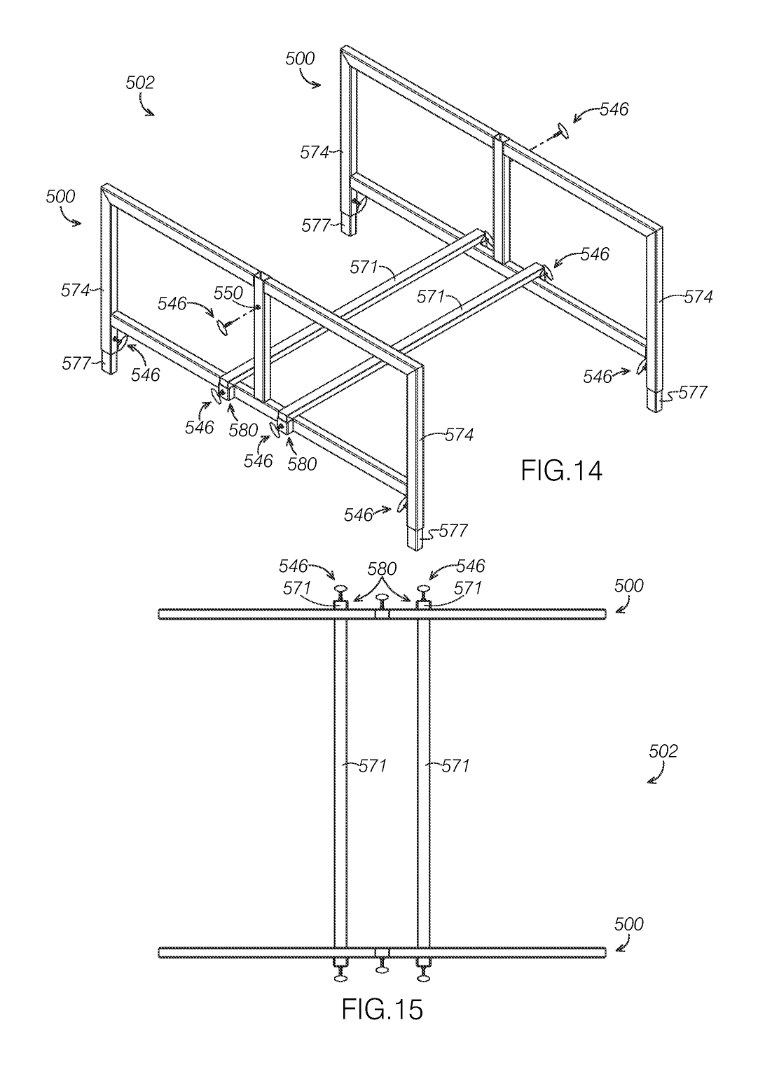

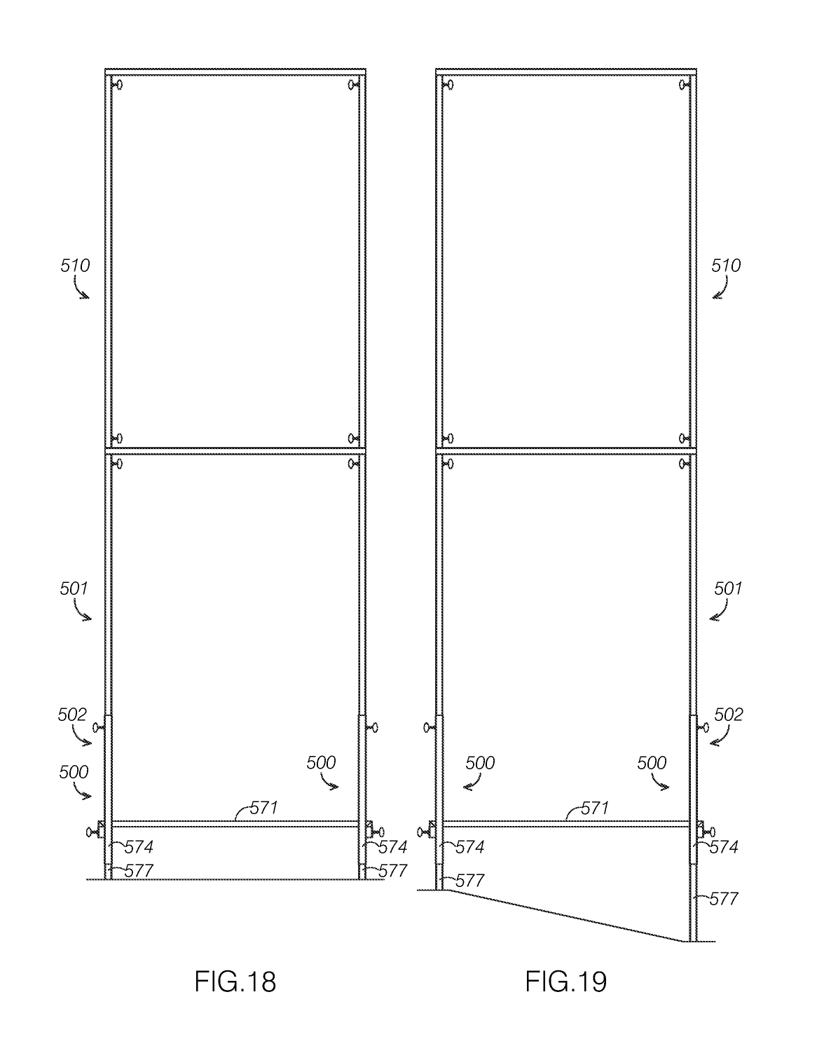

Shown perhaps most clearly in FIG. 14, connecting members 571 are configured to interconnect two side members 500, thus forming stand member assembly 502. Stand member assembly 502 provides a wide base capable of supporting frame member 510 on uneven terrain and in inclement weather. As shown in FIGS. 18 and 19, the ground engaging portion of each corner of stand member assembly 502 is configured to selectively telescope to make stand member 502 level. In this context, level refers to the state where horizontal members 572 and 576 are oriented substantially horizontal.

As shown with particularity in FIG. 17, sleeve portion 579 of vertical member 578 is configured to receive insert portion 525 of elongate side member 520. The length of side members may be selected to accommodate different purposes. For example, a 54 inch side member may be used to raise banners and other indicia higher for increased visibility. In other examples, a 28 inch side member may be used when frame system 501 is used to support hanging plant or other items that the user would be prefer to be easily in reach of people standing beside frame system 501.

Further, retaining members are fixedly attached to vertical member 578 to selectively retain insert portion 525 within sleeve portion 579. Sleeve portion 579 and insert portion 525 are configured to telescope together cooperatively to increase or decrease the height of advertising media displayed on the frame member relative to the ground.

Turning now to FIGS. 18 and 19, frame system 501 is depicted on variable terrain to demonstrate how the height of ground-engaging insert portions 577 can be adjusted to substantially level stand member assembly 502. As previously discussed, each ground-engaging insert portion 577 of stand member assembly 502 is configured to selectively telescope to adjust the height it extends beyond sleeve 575. Thus, frame system 501 allows advertising media to be readily displayed in a substantially level orientation on even terrain or on uneven terrain.

Turning now to FIGS. 20 and 21, one embodiment of a retaining assembly, retaining assembly 580, is depicted and will be discussed. Retaining assembly 580 is configured to secure components of frame system 501 together. To help understand how retaining assembly 580 functions, reference is made to FIGS. 14-17 and in particular to FIGS. 20 and 21. These figures depict how retaining assembly 580 enables connecting members 571 to be selectively secured to side members 500.

As shown in FIGS. 20 and 21, retaining assembly 580 includes a retaining bracket 582 defining a threaded bore 584 and retaining member 546, which was discussed above and includes threaded shaft 547 and head 548. Retaining bracket 582 defines bracket opening 586 to receive an end of cross member 571 and couples to side member 500 in a position where it is desired to selectively secure cross member 571 to side member 500. Threaded bore 584 is complimentarily configured with threaded shaft 547 of retaining member 546.

In the example shown in FIGS. 20 and 21, retaining member 546 defines a threaded shaft 547 complimentarily configured with threaded bore 584. As shown in FIG. 20, threaded shaft 547 of retaining member 546 is configured to thread into threaded bore 584 to engage cross member 571 disposed within opening 586 defined by retaining bracket 582. In this manner, retaining member 546 may selectively secure cross member 571 to side member 500.

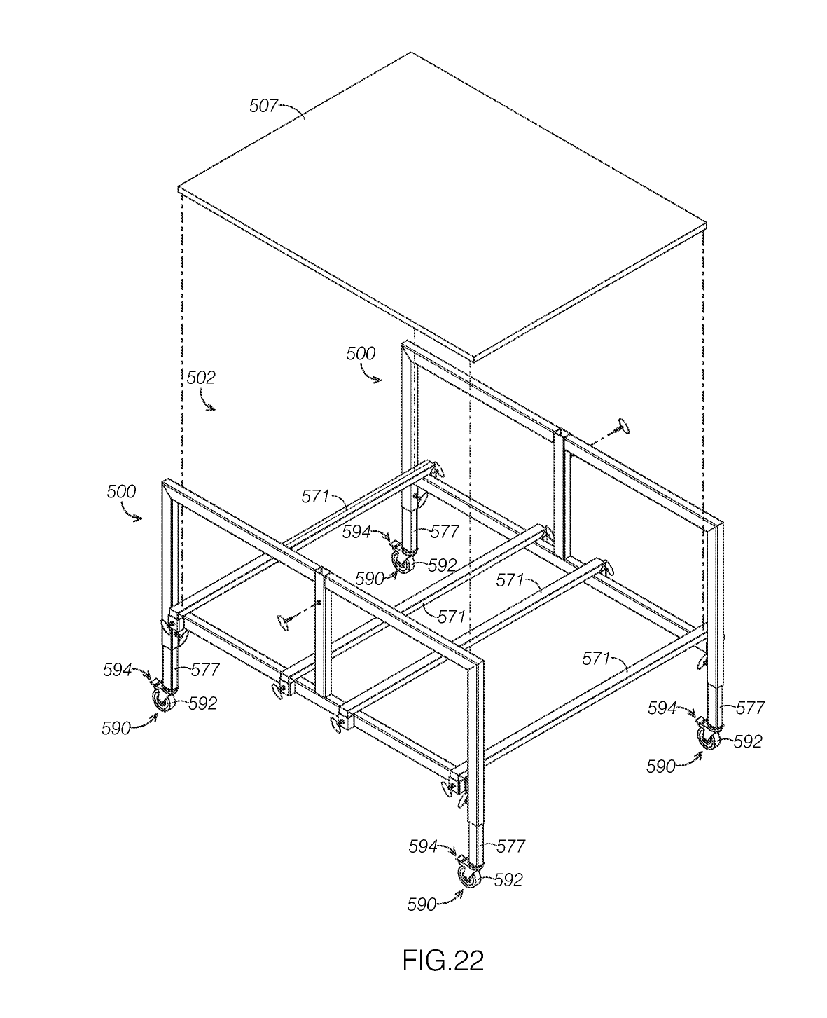

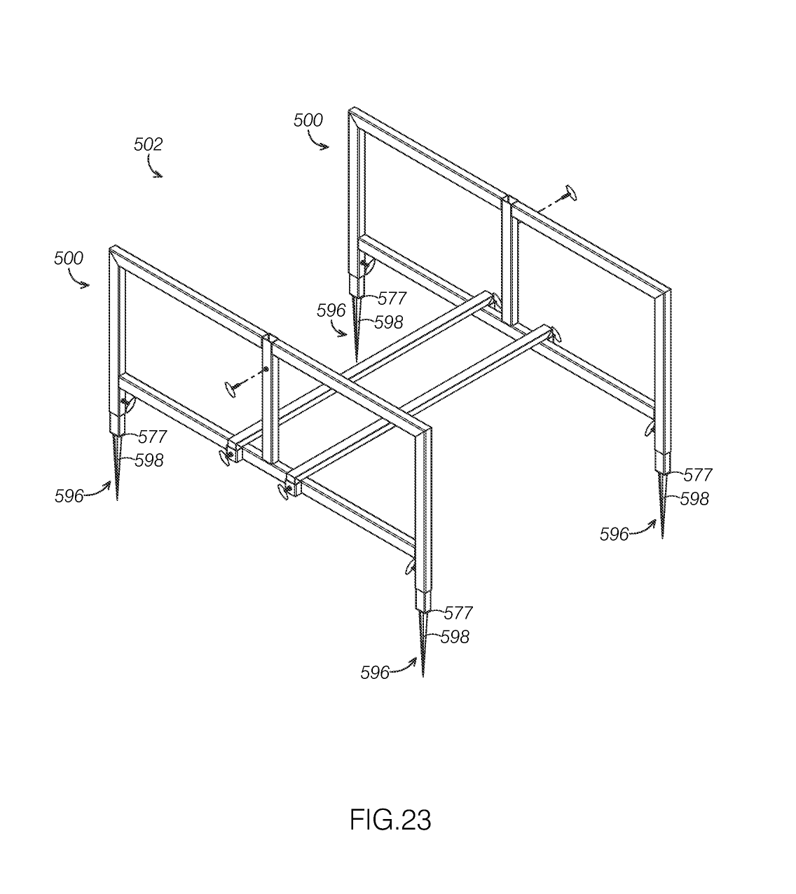

Turning now to FIGS. 22 and 23, stand member assembly 502 including optional ground-engaging elements 590 and 596, respectively, are depicted. FIG. 22 depicts stand member assembly 502 with ground engaging elements 590, which include a castor 592 and an optional brake mechanism 594. FIG. 23 depicts stand member assembly 502 with ground engaging elements 596, which include a stake 598 configured pierce the ground to restrict or prevent stand member assembly 502 from moving from a given location.

In other examples, the ground engaging elements define floor inserts. The floor inserts are made from plastic some examples. In other examples, the floor inserts are made from other materials. The floor inserts are configured to resist the stand member assembly scratching the floor on which the stand member assembly stands and to have a relatively high coefficient of friction to resist the stand member assembly moving horizontally unintentionally.

Castors 592 are configured to facilitate moving stand member assembly 502 to different locations by rolling stand member assembly 502 over the ground, a ramp, or other surface. The castors may be any conventional or later developed form of castor or wheel assembly. For example, the castors may include a single wheel, multiple wheels, or treads.

Brake mechanism 594 is configured to selectively restrict or prevent the casters from rolling to maintain stand member assembly 502 in a desired location, including on an inclined surface that might otherwise cause stand member assembly to roll downhill under the influence of gravity. In some examples, the ground engaging element does not include a brake mechanism. In the present example, brake mechanism 594 includes a lever that a user may engage with his foot to selectively engage or disengage the brake mechanism. However, any currently known or later developed form of brake mechanism may be used.

A further feature depicted in FIG. 22 is a platform 507 that may be selectively mounted on stand member assembly 502 to define a cart for supporting items. Platform 507 may be supported on the top of side members 500 to form a shelf or may be supported on connecting members 571 to form a floor. In some examples, two platforms are provided, one supported on the top of side members and one supported on connecting members to provide two levels to support objects.

As shown in FIG. 22, stand member assembly 502 includes two additional connecting members 571 extending between side members 500. Additional connecting members 571 may be selectively mounted to stand member assembly 502 to provide additional support to optional platform 507.

Platform 507 is a wood member and is sufficiently rigid to support items placed on it. In some examples, the platform is made of plywood or other types of wood. In other examples, the platform is made of metal or plastic. The platform may be any rigid member or collection of member, such as a pallet or separate planks of material, suitable for supporting items.

Although just two embodiments of ground engaging elements are depicted in FIGS. 22 and 23, various ground-engaging elements are contemplated depending on the level of mobility needed by the frame system user. For example, ground-engaging elements may include, but are not limited to, rails, wheels, treads, wedges, and dispersive disks. It is further contemplated that the ground-engaging elements may be configured to be removed and replaced quickly and easily to facilitate moving the stand member from one type of terrain to a different type of terrain.

Employing the above-described portable sign frames, as well as the components thereof, and the principles of their assembly, it is evident that a number of variations to the embodiments discussed above may be made without departing from the scope of the disclosure. For example, the overall configuration of the frames discussed above are laterally symmetrical, such as to achieve a balanced weight distribution for a user to more easily manipulate or otherwise move the frame to impart motion to a sign mounted thereto, but this is not required to all embodiments. Also, the various structural components of the frames, such as the brace members and side portions, and so forth, are shown to have a fixed length, but some embodiments may include structural components of variable length, such as by telescoping a smaller diameter piece of tubing within a larger diameter, such as to allow a user to adjust the height and/or width of a frame by telescoping the component parts of a brace member and/or side portion in order to reach a desired length.

One example application of adjustable-length structural components may be to provide a display window large enough to swingingly mount a sign to a top brace member thereof, such that the outer edge of the sign is within the perimeter of the display window. Such a configuration may allow the frame to be easier to maintain upright in windy conditions by allowing the sign to swing back and forth unobstructed by the display window, instead of maintaining the sign flat against the frame components and thus provide wind resistance.

A further variant may include the provision of connecting means, such as angled insert portions or otherwise, to allow multiple frames and/or frame components to be coupled together, such as to provide a multi-directional sign display, a free-standing sign display, and so forth.

Although the present invention has been shown and described with reference to the foregoing operational principles and illustrated examples and embodiments, it will be apparent to those skilled in the art that various changes in form and detail may be made without departing from the spirit and scope of the invention. The present invention is intended to embrace all such alternatives, modifications and variances that fall within the scope of the appended claims.

I claim:

1. A frame system for supporting indicia bearing media, comprising:
a frame member adapted to portably support indicia-bearing media and including:
a pair of elongate side members aligned in a spaced, planar relationship, each side member having a top portion and a bottom portion,
a top brace member extending between and rigidly connecting the top portions of the side members, and
a bottom brace member extending between and rigidly connecting the bottom portions or the side members and including a foot support adapted to receive a user's foot thereon, and
a middle brace member extending between the side members at a point between the top and bottom portions thereof and forming a hand support adapted to receive a user's hand thereon,
wherein one or more of the top portions of the side members, the top brace member, and the middle brace member defines a mounting site for the indicia-bearing media; and
a free-standing stand member adapted to removably receive and support the frame in a substantially upright position.

2. The frame system of claim 1, wherein:
the stand member defines a sleeve portion; and
the bottom brace member defines an insert portion configured to be removably received in the sleeve portion.

3. The frame system of claim 2, wherein the insert portion and the corresponding sleeve portion are adapted to telescope together cooperatively.

4. The frame system of claim 2, further comprising a retaining member disposed on the sleeve portion, wherein the retaining member is adapted to selectively retain the corresponding insert portion in a selected position relative to the sleeve portion.

5. The frame system of claim 4, wherein the sleeve portion defines an adjustment opening and the retaining member includes:
a receiving member defining a threaded bore aligned with the adjustment opening and fixedly secured to the sleeve portion; and
a threaded shaft complimentarily configured with the threaded bore and configured to secure the insert member in the selected position by threading into the threaded bore and extending through the adjustment opening to press against the insert member.

6. The frame system of claim 1, wherein the stand member defines a ground-engaging portion.

7. The frame system of claim 6, wherein the ground engaging portion of the stand member is configured to selectively telescope to increase the height of the stand member and correspondingly raise the indicia bearing media higher off the ground.

8. The frame system of claim 7, further comprising a platform configured to be supported by the frame member to support objects placed on the platform.

9. A frame system for supporting indicia bearing media, comprising:
a frame member adapted to portably support indicia-bearing media and including:
a pair of elongate side members aligned in a spaced, planar relationship, each side member having a top portion and a bottom portion,
a top brace member extending between and rigidly connecting the top portions of the side members, and
a bottom brace member extending between and rigidly connecting the bottom portions of the side members and including a foot support adapted to receive a user's foot thereon, and
a middle brace member extending between the side members at a point between the top and bottom portions thereof and forming a hand support adapted to receive a user's hand thereon,
wherein one or more of the top portions of the side members, the top brace member, and the middle brace member defines a mounting site for the indicia-bearing media; and
a free-standing, ground-engaging stand member adapted to removably receive and support the frame in a substantially upright position, including:
a first vertical member;
a second vertical member spaced from the first vertical member; and
a top horizontal member extending between and rigidly connected to the first vertical member and the second vertical member.

10. The frame system of claim 9, wherein:
the stand member includes a first ground engaging member and a second ground engaging member;
the first vertical member defines a first sleeve portion having a first opening proximate the ground where the first sleeve portion is adapted to removably receive the first ground engaging member; and
the second vertical member defines a second sleeve portion having a second opening proximate the ground where the second sleeve portion is adapted to removably receive the second ground engaging member.

11. The stand member of claim 10, wherein the first sleeve portion of the first vertical support member and the first ground engaging member are adapted to telescope together cooperatively.

12. The stand member of claim 11, wherein a bottom horizontal member extends between and rigidly connects the first vertical member and the second vertical member.

13. The stand member of claim 12, further comprising a third vertical member that bisects the top horizontal member and rigidly connects to the bottom horizontal member.

14. The stand member of claim 13, wherein:
the bottom portion of at least one of the side members defines an insert portion;
the third vertical member defines a third sleeve portion extending through the top horizontal member and adapted to removably receive the insert portion.

15. The stand member of claim 14, wherein the third sleeve portion of the third vertical member and the insert portion are adapted to telescope together cooperatively.

16. The stand member of claim 15, further comprising a connecting member configured to interconnect the stand member to a second stand member.

17. The stand member of claim 16, wherein the connecting member extends between and removably connects the bottom horizontal member of the stand member to a second bottom horizontal member of the second stand member.

18. A system comprising:
a frame member adapted to portably support indicia-bearing media including:
a pair of elongate side members aligned in a spaced, planar relationship, each side member having a top portion and a bottom portion,
a top brace member extending between and rigidly connecting the top portions of the side members, and
a bottom brace member extending between and rigidly connecting the bottom portions of the side members and including a foot support adapted to receive a user's foot thereon,
a middle brace member extending between the side members at a point between the top and bottom portions thereof and forming a hand support adapted to receive a user's hand thereon,
wherein one or more of the top portions of the side members, the top brace member, and the middle brace member defines a mounting site for the indicia-bearing media; and
a free-standing, ground-engaging stand member adapted to removably receive and support the frame in a substantially upright position, including:
a first vertical member;
a second vertical member spaced from the first vertical member; and
a top horizontal member extending between and rigidly connected to the first vertical member and the second vertical member,
wherein the first and second vertical members define ground engaging elements proximate the ground.

19. The stand member of claim 18, wherein the ground engaging elements are configured to restrict or prevent movement of the stand member.

20. The stand member of claim 18, wherein the ground engaging elements are configured to facilitate movement of the stand member.
